(19) United States
(12) Patent Application Publication
(10) Pub. No.: US 2011/0196906 A1
(43) Pub. Date: Aug. 11, 2011

(54) Simple and Fast Method to Find Inside Points

(76) Inventor: YikLoon Lee, Leonardtown, MD (US)

(21) Appl. No.: 12/701,230

(22) Filed: Feb. 5, 2010

(51) Int. Cl. G06F 17/15

(52) U.S. Cl. 708/424

(57) ABSTRACT

A commonly recurring computational geometry problem in many diverse science and engineering disciplines is to determine if a point is inside an enclosed body. Usually this needs to be solved for a very large set of points. Many algorithms for different applications have been proposed. But fundamentally, they are all based on the same underlying strategy of focusing solely on the 2D body surface as the defining boundary. For a general solution, these traditional algorithms remain very complex and computationally costly. A new concept for a simple and efficient approach not specifically tied to any application is described here.

### BACKGROUND OF THE INVENTION

This invention is about a new concept that results in a simple and fast method to solve a common computational geometry problem: to numerically determine which, if any, in a large logically linked set of (evaluation) points (where every point is numbered and has at least one known neighbor) are inside or outside one or more fully enclosed bodies (defined and bounded by many flat surface panels) with any complex arbitrary shape (such as the thick red outline in FIG. 1a).

Focusing solely on the 2D body surface as the defining boundary, traditional methods take an obvious and direct approach to determine (utilizing various invented techniques) independently for every point if it is inside or outside. The resulting algorithms are necessarily complex and numerically expensive because of the arbitrariness of the surface shape.

### SUMMARY OF THE INVENTION

The heart of this invention is to avoid treating the 2D body surface as the boundary and replace it with an extended and bulkier but, for the purpose of this computational problem, equivalent 3D boundary zone, which is simpler and faster to work with.

### DESCRIPTION OF THE FIGURES

FIG. 1 An arbitrarily shaped body. Black points inside the body are separated from those outside the extended body by enlarged red points that are in the zone of 3D cells (an enlarged view in b).

FIG. 2 Some regularly shaped bodies.

### DETAILED DESCRIPTION

### Preliminaries

a) The new concept takes a different and indirect approach to the problem and naturally avoids the inherent difficulties of traditional methods. The crux of the concept is based on three simple characteristics irrelevant to traditional methods.

b) The first is the recognition of the simple fact that the problem becomes quite trivial if the body in [0001] is a regularly shaped convex enclosed space defined and bounded by just a few flat surface panels like those in FIG. 2.

a) Thus it seems one obvious method would be to first fill the entire space inside the arbitrary bodies with smaller version of these regularly shaped bodies (called 3D cells here). If a point is, after a search through the cells, found to be inside one of these cells, then it is inside a body. (Note: The required cell search method is quite standard and thus not described here.)

b) But in many situations, this could be tedious and impractical.

c) It is important to note that, because of the large startup cost, this new concept which relies on simple cell search and navigation makes economic sense only if the number of evaluation points is large.

The Concept: Replacing the Boundary Surface with a 3D Zone

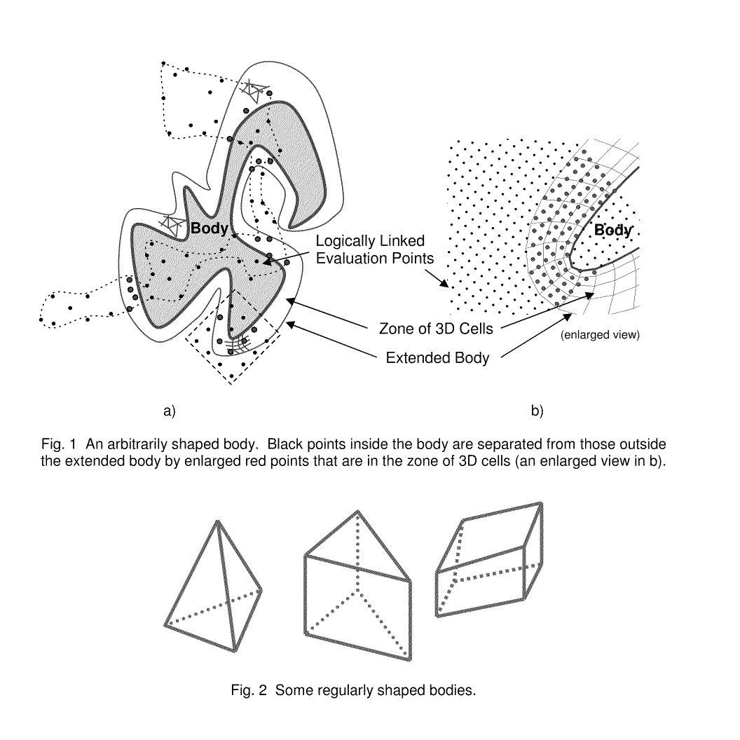

a) The second is the realization that a similar effect to [0005] can be achieved by doing the same from the opposite end, that is, by filling some of the space immediately outside the bodies with 3D cells (see “Zone of 3D Cells” in FIG. 1).

b) One advantage of this opposite approach is that these cells only need to fill the space up to a certain extent away from (but not too close to) the body surface. The procedure to determine the extent is not part of the claim here and there is considerable leeway in its determination. But, like the body surface, the cells must completely surround the bodies. Another advantage is, in many situations, these external cells are either already available or easy to generate. The body plus the boundary zone of 3D cells can be considered informally as the extended body (thin red outline in FIG. 1) the shape of which may no longer reflect the original body.

c) For all computational purposes, this zone of cells attached to the body surface now replaces that surface as the designated boundary zone and the surface subsequently loses its traditional significance.

### The Concept: Replacing (Again) the Boundary Zone

a) Those points that, after the standard cell search process, are found anywhere inside this zone of cells are marked (as enlarged red points in FIG. 1a, b).

b) The third and last critical characteristic to note is that these marked points too, similar to the body surface or its attached cell zone, always serve as a dividing boundary to logically (but not necessarily physically) separate those points that are inside the body and those that are outside the extended body (in- and outside black points in FIG. 1). In effect, the zone of 3D cells is now replaced (once again) by a subset of evaluation points as the boundary zone.
c) Since all inside points are now logically isolated, the original problem is now, at least in principle, solved. Because all points are logically linked, the inside points can be subsequently found one by one following the link.

### Summary

a) In summary, this new concept transforms the original problem A) of in/out status described in [0001] that uses the 2D body surface as the defining in/out boundary, to an equivalent problem B) that uses the zone of additionally generated 3D cells completely surrounding the body as the new in/out boundary zone. The latter problem is to determine which points are inside that zone. This is much easier and faster to solve than the original problem A) because of [0004]b) above, and any quick standard cell search technique suffices. Cell search is where almost all the computation lies. The search results effectively transforms the problem B) yet again into another, C), that uses the points in the zone of 3D cells (as opposed to the body surface in A or the cell zone itself in B) as the new in/out logical boundary zone to isolate the inside points.

b) In exchange for its advantages, this new concept requires that a zone of 3D cells be present and that the evaluation points be logically linked, neither of which is unreasonably demanding in many situations.

c) In effect, the concept merely transforms the dividing boundary from the 2D body surface to a subset of evaluation points.

d) The details explained in [0006] and [0007] are the heart of this new concept.

The two root causes of the algorithmic complexity and inefficiency of traditional methods for large number of evaluation points are a) the focus on the 2D body surface as the defining boundary which the new concept avoids by transformations to an equivalent problem, and b) the inability to amortize the cost of (i.e., utilizing results from) other previously evaluated points. In contrast, cell searches for large number of points can be significantly accelerated by amortizing the cost.

Further numerical procedures to optimally acquire or compute the data/info required for realistic individual applications are not part of the claim here.

We claim

1) a new concept that results in a simple and fast method to numerically determine which, if any, in a large logically linked set of points are inside or outside one or more fully enclosed bodies (defined and bounded by many flat surface panels) with any complex arbitrary shape (such as the thick red outline in FIG. 1).

2) Replacing the Boundary Surface with a 3D Zone—For computational purpose, it is advantageous to replace the 2D body surface with a zone of 3D cells (FIG. 1) attached to and completely surrounding the surface as the designated boundary zone: The surface loses its traditional importance as the dividing boundary. The body plus the boundary zone can be considered as the extended body (thin red outline in FIG. 1) the shape of which may no longer reflect the original body. Although it seems less well defined than the body surface, the new zone of cells allows the use of a standard cell search procedure to find the boundary.

3) Replacing (Again) the Boundary Zone—The points that are found (using a cell search procedure) anywhere inside the boundary zone always serve, similar to the body surface or its attached zone of cells, as a dividing boundary to logically (but not necessarily physically) separate those points that are inside the body and those that are outside the extended body (in- and outside black points in FIG. 1). In effect, the original 2D body surface is replaced by a subset of evaluation points as the final boundary representation. Since all inside points are now logically isolated, the original problem is now, in principle, solved.
